(19) United States
(12) Patent Application Publication
(10) Pub. No.: US 2021/0211525 A1
(43) Pub. Date: Jul. 8, 2021

(54) MULTI-DIMENSIONAL MEDIA DATA TRANSMISSION METHOD AND APPARATUS, ELECTRONIC DEVICE, AND STORAGE MEDIUM

(71) Applicant: BEIJING XIAOMI MOBILE SOFTWARE CO., LTD., Beijing (CN)

(72) Inventor: Li HE, Beijing (CN)

(73) Assignee: BEIJING XIAOMI MOBILE SOFTWARE CO., LTD., Beijing (CN)

(21) Appl. No.: 16/894,629

(22) Filed: Jun. 5, 2020

(30) Foreign Application Priority Data
Jan. 8, 2020 (CN) 202010017667.8

(51) Int. Cl. H04L 29/06; H04L 29/08

(52) U.S. Cl. CPC H04L 69/26; H04L 69/324; H04L 69/03

(57) ABSTRACT

A multi-dimensional media data transmission method includes: acquiring function types of multi-dimensional media data to be transmitted, in which the media data of different dimensions correspond to different function types; determining an electronic device for outputting media data corresponding to a function type; packaging the media data corresponding to the function type according to a communication protocol type of the electronic device, and transmitting the packaged media data through a communication interface corresponding to the electronic device.

### CROSS-REFERENCE TO RELATED APPLICATION

This application claims priority to Chinese Patent Application No. 202010017667.8 filed on Jan. 8, 2020, the disclosure of which is hereby incorporated by reference in its entirety.

### BACKGROUND

With the increasing popularity of four-dimensional (4D) theaters, five-dimensional (5D) theaters have developed on the basis of 4D theaters. 5D theaters can integrate vision, hearing, smell, touch, and motion. When watching a movie, a user can not only “touch” objects in the movie, but also “encounter” scenes of wind, rain, and thunder-and-lightning, and the experience can be immersive.

### SUMMARY

The present disclosure relates generally to data transmission technologies, and more specifically to a multi-dimensional media data transmission method and a multi-dimensional media data transmission apparatus, an electronic device, and a storage medium.

In a first aspect of embodiments of the present disclosure, a multi-dimensional media data transmission method is provided. The method includes: acquiring a plurality of function types of multi-dimensional media data to be transmitted, in which the media data of different dimensions correspond to different function types; determining an electronic device for outputting media data corresponding to a function type; and packaging the media data corresponding to the function type according to a communication protocol type of the electronic device, and transmitting the packaged media data through a communication interface corresponding to the external device.

In a second aspect of embodiments of the present disclosure, a multi-dimensional media data transmission apparatus is provided. The apparatus includes: a function type acquisition module, configured to acquire a plurality of function types of multi-dimensional media data to be transmitted, in which the media data of different dimensions correspond to different function types; an external device determination module, configured to determine an external device for outputting media data corresponding to a function type; and a media data packaging module, configured to package the media data corresponding to the function type according to a communication protocol type of the electronic device, and to transmit the packaged media data through a communication interface corresponding to the external device.

In a third aspect of embodiments of the present disclosure, an electronic device is provided. The electronic device includes a processor and a memory configured to store instructions executable by the processor. The processor is configured to execute the instructions stored in the memory to implement the method according to any one of the above embodiments.

In a fourth aspect of the embodiments of the present disclosure, a readable storage medium is provided. The storage medium has executable instructions stored thereon that, when executed by a processor, implement the method according to any one of the above embodiments.

It is understood that the above general description and the following detailed description are only exemplary and explanatory, and do not limit the present disclosure.

### BRIEF DESCRIPTION OF THE DRAWINGS

The accompanying drawings, which are incorporated in and constitute a part of this disclosure, illustrate embodiments consistent with the present disclosure and, together with the description, serve to explain the principles of the present disclosure.

FIG. 1 is a schematic diagram illustrating an application scenario according to some embodiments.

FIG. 2 is a flowchart of a multi-dimensional media data transmission method according to some embodiments.

FIG. 3 is a flowchart of determining an external device according to some embodiments.

FIG. 4 is a flowchart of determining an external device according to another exemplary embodiment.

FIG. 5 is a flowchart of a multi-dimensional media data transmission method according to another exemplary embodiment.

FIG. 6 is a first block diagram illustrating a multi-dimensional media data transmission apparatus according to some embodiments.

FIG. 7 is a second block diagram illustrating a multi-dimensional media data transmission apparatus according to some embodiments.

FIG. 8 is a third block diagram illustrating a multi-dimensional media data transmission apparatus according to some embodiments.

FIG. 9 is a fourth block diagram illustrating a multi-dimensional media data transmission apparatus according to some embodiments.

FIG. 10 is a fifth block diagram illustrating a multi-dimensional media data transmission apparatus according to some embodiments.

FIG. 11 is a block diagram of an electronic device according to some embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

Currently, each manufacturer has its own solution in designing 5D theaters. The solutions of various manufacturers include different central control units, peripheral interfaces and supporting hardware and software equipment. Since these solutions are relatively closed and generally incompatible with each other, once the design is completed, there may be a problem that some hardware resources or upper-layer application software cannot be shared, which is not conducive to the extension of 5D theaters.

Various embodiments of the present disclosure provide a multi-dimensional media data transmission method, which can be applied to an electronic device provided with a communication interface, such as a television, a speaker, a seat, and the like. The communication interface may be communication interfaces such as a USB interface or an infrared communication interface.

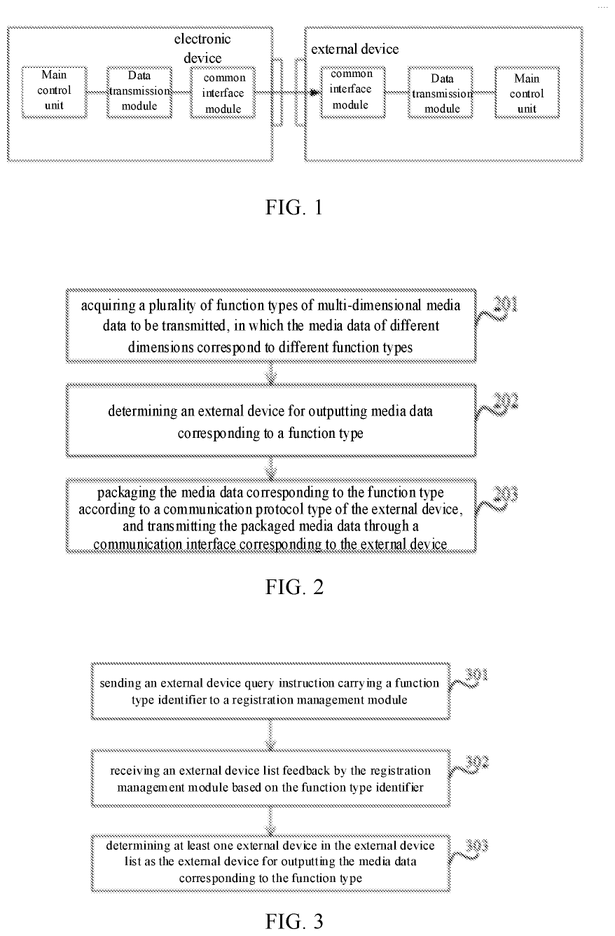

FIG. 1 is a schematic diagram illustrating an application scenario according to some embodiments. The electronic device may send multi-dimensional media data to an external electronic device (hereinafter referred to as an external device to be distinguished), so that the external device can perform corresponding operations, such as example, display, sound, vibration, and the like. The dimensions of the multi-dimensional media data may be at least one of vision, hearing, smell, touch and motion. Those skilled in the art can adjust the dimensions of the media data according to a specific scenario, and the corresponding solution falls within the protection scope of the present disclosure.

In this embodiment, both the electronic device and the external device are provided with a driving module, and the driving module can be implemented by software or hardware. Taking software implementation as an example, the drive module may be provided inside a main control module or a communication interface, or may exist separately as one module, either way, the solution falls within the protection scope of the present disclosure. In subsequent embodiments, the driving module is separately provided for convenience of description.

FIG. 2 is a flowchart of a multi-dimensional media data transmission method according to some embodiments. As illustrated in FIG. 2, the multi-dimensional media data transmission method includes actions at blocks 201-203.

At block 201, a plurality of function types of multi-dimensional media data to be transmitted is acquired, in which the media data of different dimensions correspond to different function types.

In an embodiment of the present disclosure, a main control module in the electronic device may acquire the multi-dimensional media data to be transmitted in response to upper-layer applications, for example, when a user watches videos or plays audios. The multi-dimensional media data is parsed to obtain the function types of media data in respective dimensions. The function type may be one of vision, hearing, smell, touch and motion. Certainly, those skilled in the art may set the function types according to specific scenarios, which is not limited here.

In an embodiment of the present disclosure, each function type corresponds to one preset communication protocol. For example, for five-dimensional (5D) multi-dimensional media data, the preset communication protocol types correspond to the data of five dimensions, i.e., data of video, audio, smell, touch, and dynamic, are Video_5D, Audio_5D, Smell_5D, Touch_5D, and Dynamic_5D respectively. In an embodiment of the present disclosure, the preset communication protocol may be understood as a standard format of various industries under the current circumstances, so that the user does not need to define his own data format, which is conducive to subsequent extension.

In an embodiment of the present disclosure, after acquiring a function type of data of a dimension in the multi-dimensional media data, the main control module may send a preset communication protocol type corresponding to the function type as a control instruction to a drive module, to inform the drive module that there is media data of the function type corresponding to the preset communication protocol type that needs to be sent.

At step 202, an external device for outputting media data corresponding to a function type is determined.

In an embodiment of the present disclosure, as illustrated in FIG. 3, the electronic device may send an external device query instruction carrying a function type identifier to a registration management module (corresponding to an action at block 301). Then, an external device list feedback by the registration management module based on the function type identifier may be received (corresponding to an action at block 302). Afterwards, at least one external device in the external device list may be determined as the external device for outputting the media data corresponding to the function type, in which the external device for outputting the media data corresponding to the function type is registered with the registration management module in advance (corresponding to an action at block 303).

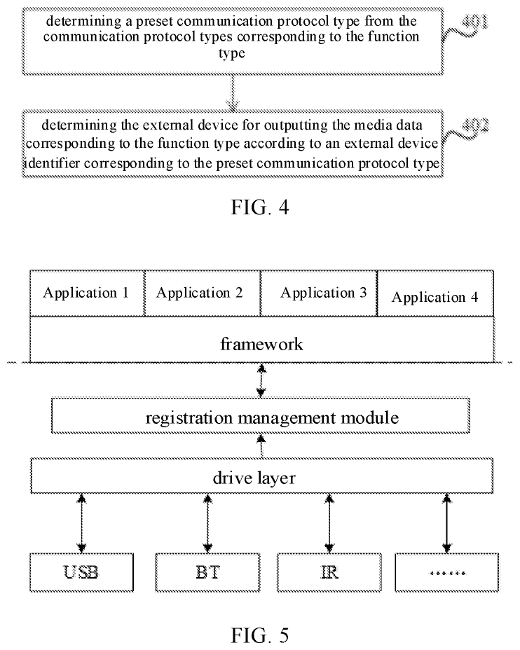

In another embodiment, the external device list carries external device identifiers and communication protocol types corresponding to the function type. Thus, as illustrated in FIG. 4, the external device may be determined by follows. For each function type, a preset communication protocol type is determined from the communication protocol types corresponding to the function type (corresponding to an action at block 401). The external device for outputting the media data corresponding to the function type is determined according to an external device identifier corresponding to the preset communication protocol type (corresponding to an action at block 402).

In yet another embodiment, considering historical query situation, a historical query result may be obtained, an external device historically-used for transmitting the multimedia data corresponding to the function type is determined as the external device for transmitting the multimedia data corresponding to the function type in this transmission.

A registration process of the external device may be described as follows.

In an embodiment of the present disclosure, when the external device accesses a communication interface of the electronic device through a communication interface of the external device, the two communication interfaces perform a handshake. After the handshake is successful, the external device applies for registration. During registration, the external device sends its own function type and communication protocol type to the electronic device. The registration management module in the electronic device may determine the preset communication protocol type according to the function type of the external device, and then may generate registration information of the external device according to the function type, the preset communication protocol type and the communication protocol type, and stores the registration information in a specified location, such as a specified area of a local memory or a buffer memory).

For example, the external device may be a functional device that is able to produce at least one of visual, auditory, olfactory, tactile and dynamic effects. For example, the external device may be an odor generator. These effects correspond to the function types of vision, hearing, smell, touch and motion respectively.

In an embodiment of the present disclosure, the preset communication protocol type can be determined according to the function type of the registered external device. Common communication protocol types (such as a USB communication protocol type, an infrared communication protocol type, a Bluetooth communication protocol type, etc.) are classified into respective preset communication protocol types. For example, the external device is an odor generator based on USB communication protocol type, then a preset communication protocol type corresponding to the external device is Smell_5D.

In another embodiment, after the external device accesses the communication interface of the electronic device through the communication interface of itself, the registration is performed during the handshake process between the two communication interfaces.

At step 203, the media data corresponding to the function type is packaged according to a communication protocol type of the external device, and the packaged media data is transmitted through a communication interface corresponding to the external device.

In an embodiment of the present disclosure, the multi-dimensional media data to be transmitted may be obtained from the main control module, and the multi-dimensional media data to be transmitted may be packaged according to the communication protocol type to obtain a pack header.

For example, when the communication protocol type is an infrared wireless transmission protocol, the drive module may generate a pack header for the multi-dimensional media data according to the function type, the communication protocol type, and the preset communication protocol type. The pack header may be as follows.

{Output_Name|Custom_Data|Data_Code|Stop_Bit};

Wherein, Output_Name represents the preset communication protocol type; Custom_Data represents a decoding header field of infrared wireless transmission, configured to distinguish different infrared wireless transmission protocols; Data_Code represents the function type, configured to indicate what kind of operation is performed to the multi-dimensional media data, such as audio playback, video playback, or the like. Stop_Bit is an end marker for infrared timing.

For another example, in a case where the communication protocol type is a USB transmission protocol, in response to the communication protocol type, the drive module may generate a pack header based on the communication protocol type and operation instructions of the multi-dimensional media data according to the preset communication protocol type.

Considering that the USB transmission protocol includes token packets, data packets and handshake packets, in an embodiment, the data packets may be packaged, and a format of the pack header may be as follows:

{Output_Name|Control_Data};

Wherein, Output_Name represents the preset communication protocol type, Control_Data refers to the function type, configured to indicate what kind of operations are performed on the multi-dimensional media data, such as audio playback, video playback, or the like.

It is noted that, the drive module may process the token packets and the handshake packets according to a packaging format specified by the USB transmission protocol, and specific packaging content can be referred to the related art, which is not limited herein.

It is noted that, for other communication protocol types, pack header formats can be set correspondingly to adaptively package the multi-dimensional media data.

In an embodiment of the present disclosure, after adding the pack header to the multi-dimensional media data to be transmitted, the drive module may send the packed multi-dimensional media data to the corresponding communication interface, so as to achieve the effect of sending the multi-dimensional media data to the external device. Since the media data is repackaged according to the communication protocol type of each external device, the external device can use a common interface to realize communication, thereby enabling cross-device transmission of media data. That is, the same media data is sent to external devices of the same function type, which is convenient for extension and system development.

The above embodiment describes a solution in which the electronic device sends the multi-dimensional media data to the external device. In an embodiment, the electronic device may also receive multi-dimensional media data (hereinafter referred to as second data for distinguishing) sent from the external device. For example, when the electronic device receives the packaged second data via the communication interface, the drive module may unpackage the second data. For example, the drive module can obtain a system interface type of the main control module in the electronic device. The system interface type may include at least one of Linux system and Android system. Then, the drive module may unpackage the received second data according to the system interface type to obtain the multi-dimensional media data. Afterwards, the drive module can send the multi-dimensional media data to the main control module, such that the main control module processes the multi-dimensional media data. In this way, the electronic device can be used as a two-way multi-dimensional media data transmission device to realize output and reception of multi-dimensional media data.

It is noted that a data transmission module can be used for outputting multi-dimensional media data, inputting multi-dimensional media data, or inputting and outputting multi-dimensional media data. Correspondingly, the electronic device may have a data output function (such as an image or voice interaction device) only, a data input function (such as touch, motion, and smell device) only, or a data input and output function (such as a visual device). Those skilled in the art can make settings according to specific scenarios, and corresponding solutions fall within the protection scope of the present disclosure.

With the embodiments of the present disclosure, the function types of the multi-dimensional media data to be transmitted are obtained, in which the media data of different dimensions correspond to different function types. The external device for outputting the media data corresponding to the function type is determined. The media data corresponding to the function type is packaged according to the communication protocol type of the electronic device and then transmitted through the communication interface corresponding to the external device. In the embodiment, the media data is packaged according to the communication protocol type of the external device, and the media data of various dimensions is transmitted, which is beneficial to use a common interface to transmit the multi-dimensional media data, and convenient for extending the external device, such as sharing hardware resources or developing upper layer application software. As such, a good open-source software and hardware ecosystem is established.

A multi-dimensional media data transmission method provided by an embodiment of the present disclosure will be described in the following in combination with a specific scenario. As illustrated in FIG. 5, a registration management module is set in an electronic device. An external device registers with the registration management module through a driver layer in the electronic device. At this time, the driver layer can add a data structure to store a function type of the external device: function_type. Certainly, a data structure can also be added to the external device to store a function type of the external device. It may be understood that the above function type needs to be consistent with a function type in a preset communication protocol type.

When a user triggers an application, a system upper framework layer may obtain the function types of the media data of respective dimensions in the multi-dimensional media data, and may query the registration management module (namely, a register manager) through a broadcast way to obtain an available external device list. Then, the data packets are packaged respectively according to the communication protocol type (USB, IR, Bluetooth (BT), Wi-Fi) corresponding to each external device in the external device list, and the packaged data is transmitted to a corresponding communication interface through the driver layer, and then sent to a corresponding external device by the communication interface.

It is noted that, in the embodiment, the multi-dimensional media data may be of a cross-device type, and broadcast instructions are sent to all the external devices that meet the function type. The driver layer packages and transmits the media data for each type of communication interfaces. In other words, the media data of the same function type may be sent to all external devices of this function type at the same time, that is, external devices of the same function type operate simultaneously.

Certainly, the driver layer may also add serial numbers for the external devices of the same function type, such as a, b, c, d . . . , which is fed back to the framework layer through the driver layer. The framework layer adds a specific serial number for an external device when issuing a function type according to requirements. For example, the serial number may be added after the function type function_type as follows.

{function_type|device_type|index};

Wherein, device_type and index can be default. By default, it means that all external devices of the same function type operate simultaneously.

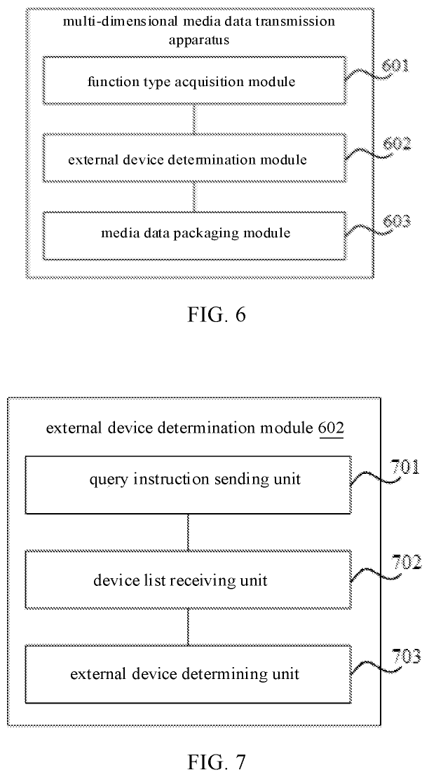

FIG. 6 is a block diagram of a multi-dimensional media data transmission apparatus according to some embodiments. As illustrated in FIG. 6, the multi-dimensional media data transmission apparatus includes a function type acquisition module 601, an external device determination module 602, and a media data packaging module 60.

The function type acquisition module 601 is configured to acquire a plurality of function types of multi-dimensional media data to be transmitted, in which the media data of different dimensions correspond to different function types.

The external device determination module 602 is configured to determine an external device for outputting media data corresponding to a function type.

The media data packaging module 603 is configured to package the media data corresponding to the function type according to a communication protocol type of the electronic device and to transmit the packaged media data through a communication interface corresponding to the external device.

In an embodiment, as illustrated in FIG. 7, the external device determination module 602 includes a query instruction sending unit 701, a device list receiving unit 702, and an external device determining unit 703.

The query instruction sending unit 701 is configured to send an external device query instruction carrying a function type identifier to a registration management module.

The device list receiving unit 702 is configured to receive an external device list feedback by the registration management module based on the function type identifier.

The external device determining unit 703 is configured to determine at least one external device in the external device list as the external device for outputting the media data corresponding to the function type.

The external device for outputting the media data corresponding to the function type is registered with the registration management module in advance.

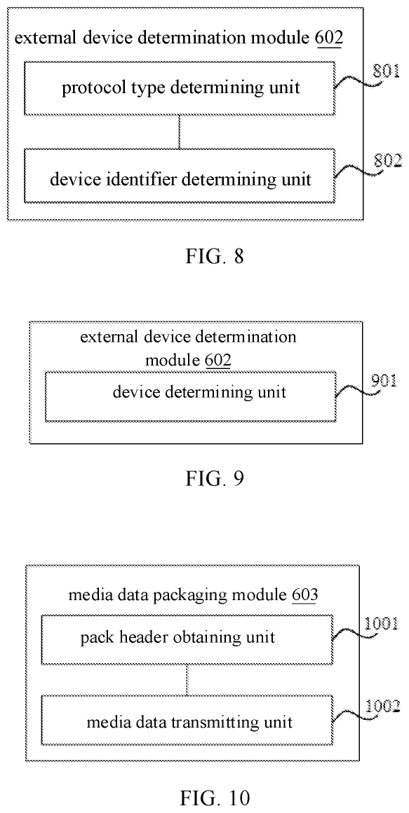

In an embodiment, as illustrated in FIG. 8, the external device list carries external device identifiers and communication protocol types corresponding to the function type, and the external device determining module 602 includes a protocol type determining unit 801 and a device identifier determining unit 802.

The protocol type determining unit 801 is configured to determine a preset communication protocol type from the communication protocol types corresponding to the function type.

The device identifier determining unit 802 is configured to determine the external device for outputting the media data corresponding to the function type according to an external device identifier corresponding to the preset communication protocol type.

In an embodiment, as illustrated in FIG. 9, the external device determining module 602 includes a device determining unit 901.

The device determining unit 901 is configured to determine an external device historically-used for transmitting the multimedia data corresponding to the function type as the external device for transmitting the multimedia data corresponding to the function type in this transmission according to a historical query result.

In an embodiment, as illustrated in FIG. 10, the media data packaging module 603 includes a pack header obtaining unit 1001 and a media data transmitting unit 1002.

The pack header obtaining unit 1001 is configured to generate a pack header for the media data according to the function type, the communication protocol type, and a preset communication protocol type.

The media data transmitting unit 1002 is configured to add the pack header to the media data and to transmit the packed media data to the communication interface corresponding to the external device.

With respect to the devices in the above embodiments, the specific manners for performing operations for individual modules therein have been described in detail in the embodiments regarding the method, which will not be described herein.

With the embodiments of the present disclosure, the function types of the multi-dimensional media data to be transmitted are obtained, in which the media data of different dimensions correspond to different function types. The external device for outputting the media data corresponding to the function type is determined. The media data corresponding to the function type is packaged according to the communication protocol type of the electronic device and then transmitted through the communication interface corresponding to the external device. In the embodiment, the media data is packaged according to the communication protocol type of the external device, and the media data of various dimensions is transmitted, which is beneficial to use a common interface to transmit the multi-dimensional media data, and convenient for extending the external device, such as sharing hardware resources or developing upper layer application software, thus a good open source software and hardware ecosystem is established.

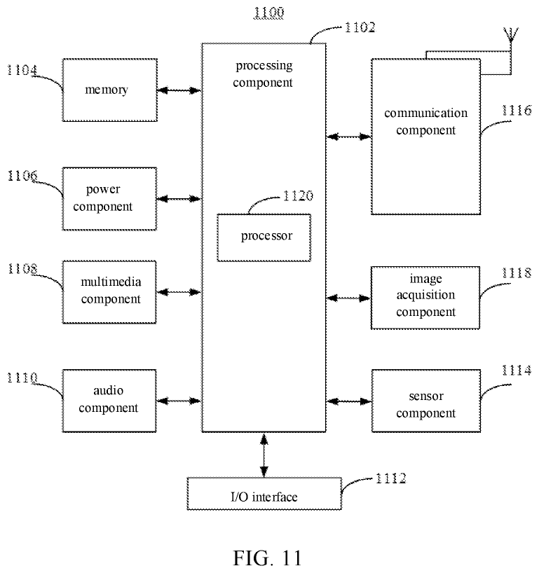

FIG. 11 is a block diagram of an electronic device according to some embodiments. For example, the electronic device 1100 may be a smart phone, a computer, a digital broadcasting terminal, a tablet device, a medical device, a fitness device, a personal digital assistant, and the like.

As illustrated in FIG. 11, the electronic device 800 may include one or more of the following components: a processing component 1102, a memory device 1104, a power component 1106, a multimedia component 1108, an audio component 1110, an input/output (I/O) interface 1112, and a sensor component 1114, a communication component 1116, and an image acquisition component 1118.

The processing component 1102 typically controls overall operations of the electronic device 1100, such as the operations associated with display, telephone calls, data communications, camera operations, and recording operations. The processing component 1102 may include one or more processors 1120 to execute instructions to perform all or part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the electronic device 1100. Examples of such data include instructions for any applications or methods operated on the electronic device 1100, contact data, phonebook data, messages, pictures, video, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the electronic device 1100. The power component 1106 may include a power management system, one or more power sources, and any other components associated with the generation, management, and distribution of power in the electronic device 1100.

The multimedia component 1108 includes a screen providing an output interface between the electronic device 1100 and a target object. In some embodiments, the screen may include a liquid crystal display (LCD) and a touch panel (TP). In some embodiments, organic light-emitting diode (OLED) or other types of displays can be employed.

If the screen includes the touch panel, the screen may be implemented as a touch screen to receive input signals from the target object. The touch panel includes one or more touch sensors to sense touches, swipes, and gestures on the touch panel. The touch sensors may not only sense a boundary of a touch or swipe action, but also sense a period of time and a pressure associated with the touch or swipe action.

The audio component 1110 is configured to output and/or input audio signals. For example, the audio component 1110 includes a microphone (“MIC”) configured to receive an external audio signal when the electronic device 1100 is in an operation mode, such as a call mode, a recording mode, and a multi-dimensional media data transmission mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, buttons, and the like.

The sensor component 1114 includes one or more sensors to provide status assessments of various aspects of the electronic device 1100. For instance, the sensor component 1114 may detect an open/closed status of the electronic device 1100, relative positioning of components, e.g., the display and the keypad, of the electronic device 1100, a change in position of the electronic device 1100 or a component of the electronic device 1100, a presence or absence of target object contact with the electronic device 1100, an orientation or an acceleration/deceleration of the electronic device 1100, and a change in temperature of the electronic device 1100.

The communication component 1116 is configured to facilitate communication, wired or wirelessly, between the electronic device 1100 and other devices. The electronic device 1100 can access a wireless network based on a communication standard, such as Wi-Fi, 2G, 3G, 4G, 5G, or a combination thereof. In one exemplary embodiment, the communication component 1116 receives a broadcast signal or broadcast associated information from an external broadcast management system via a broadcast channel. In one exemplary embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the electronic device 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 1104, executable by the processor 1120 in the electronic device 1100, for performing the above-described methods. For example, the non-transitory computer-readable storage medium may be a ROM, a RAM, a CD-ROM, a magnetic tape, a floppy disc, an optical data storage device, and the like.

The various device components, modules, units, blocks, or portions may have modular configurations, or are composed of discrete components, but nonetheless can be referred to as “modules” in general. In other words, the “components,” “modules,” “blocks,” “portions,” or “units” referred to herein may or may not be in modular forms, and these phrases may be interchangeably used.

In the present disclosure, the terms “installed,” “connected,” “coupled,” “fixed” and the like shall be understood broadly, and can be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms in the present disclosure can be understood by those of ordinary skill in the art on a case-by-case basis.

In the description of the present disclosure, the terms “one embodiment,” “some embodiments,” “example,” “specific example,” or “some examples,” and the like can indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described can be combined in a suitable manner in any one or more embodiments or examples. In addition, various embodiments or examples described in the specification, as well as features of various embodiments or examples, can be combined and reorganized.

In some embodiments, the control and/or interface software or app can be provided in a form of a non-transitory computer-readable storage medium having instructions stored thereon is further provided. For example, the non-transitory computer-readable storage medium can be a ROM, a CD-ROM, a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium can be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors or processing circuits suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode), or any other monitor for displaying information to the user and a keyboard, a pointing device, e.g., a mouse, trackball, etc., or a touch screen, touch pad, etc., by which the user can provide input to the computer.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components.

The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

It should be understood that “a plurality” or “multiple” as referred to herein means two or more. “And/or,” describing the association relationship of the associated objects, indicates that there may be three relationships, for example, A and/or B may indicate that there are three cases where A exists separately, A and B exist at the same time, and B exists separately. The character “/” generally indicates that the contextual objects are in an “or” relationship.

In the present disclosure, it is to be understood that the terms “lower,” “upper,” “under” or “beneath” or “underneath,” “above,” “front,” “back,” “left,” “right,” “top,” “bottom,” “inner,” “outer,” “horizontal,” “vertical,” and other orientation or positional relationships are based on example orientations illustrated in the drawings, and are merely for the convenience of the description of some embodiments, rather than indicating or implying the device or component being constructed and operated in a particular orientation. Therefore, these terms are not to be construed as limiting the scope of the present disclosure.

Moreover, the terms “first” and “second” are used for descriptive purposes only and are not to be construed as indicating or implying a relative importance or implicitly indicating the number of technical features indicated. Thus, elements referred to as “first” and “second” may include one or more of the features either explicitly or implicitly. In the description of the present disclosure, “a plurality” indicates two or more unless specifically defined otherwise.

In the present disclosure, a first element being “on” a second element may indicate direct contact between the first and second elements, without contact, or indirect geometrical relationship through one or more intermediate media or layers, unless otherwise explicitly stated and defined. Similarly, a first element being “under,” “underneath” or “beneath” a second element may indicate direct contact between the first and second elements, without contact, or indirect geometrical relationship through one or more intermediate media or layers, unless otherwise explicitly stated and defined.

Some other embodiments of the present disclosure can be available to those skilled in the art upon consideration of the specification and practice of the various embodiments disclosed herein. The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims.

1. A multi-dimensional media data transmission method, comprising:
acquiring a plurality of function types of multi-dimensional media data to be transmitted, wherein the multi-dimensional media data of different dimensions correspond to different function types;
determining an external device for outputting media data corresponding to a function type; and
packaging the media data corresponding to the function type according to a communication protocol type of the external device, and transmitting the packaged media data through a communication interface corresponding to the external device.

2. The method according to claim 1, wherein the determining the external device for outputting the media data corresponding to the function type comprises:
sending an external device query instruction carrying a function type identifier to a registration management module;
receiving an external device list feedback by the registration management module based on the function type identifier;
determining at least one external device in the external device list as the external device for outputting the media data corresponding to the function type;
wherein the external device for outputting the media data corresponding to the function type is registered with the registration management module in advance.

3. The method according to claim 2, wherein the external device list carries external device identifiers and communication protocol types corresponding to the function type; and
The determining the external device for outputting the media data corresponding to the function type comprises:
determining a preset communication protocol type from the communication protocol types corresponding to the function type; and
determining the external device for outputting the media data corresponding to the function type according to an external device identifier corresponding to the preset communication protocol type.

4. The method according to claim 1, wherein the determining the external device for outputting the media data corresponding to the function type comprises:
determining an external device historically-used for transmitting the multimedia data corresponding to the function type as the external device for transmitting the multimedia data corresponding to the function type in this transmission according to a historical query result.

5. The method according to claim 1, wherein the packaging the media data corresponding to the function type according to the communication protocol type of the external device comprises:
generating a pack header for the media data according to the function type, the communication protocol type, and a preset communication protocol type; and
adding the pack header to the media data corresponding to the function type, and transmitting the packed media data to the communication interface corresponding to the external device.

6. The method according to claim 2, wherein the packaging the media data corresponding to the function type according to the communication protocol type of the external device comprises:
generating a pack header for the media data according to the function type, the communication protocol type, and a preset communication protocol type; and
adding the pack header to the media data corresponding to the function type, and transmitting the packed media data to the communication interface corresponding to the external device.

7. The method according to claim 3, wherein the packaging the media data corresponding to the function type according to the communication protocol type of the external device comprises:
generating a pack header for the media data according to the function type, the communication protocol type, and a preset communication protocol type; and
adding the pack header to the media data corresponding to the function type, and transmitting the packed media data to the communication interface corresponding to the external device.

8. The method according to claim 4, wherein the packaging the media data corresponding to the function type according to the communication protocol type of the external device comprises:
generating a pack header for the media data according to the function type, the communication protocol type, and a preset communication protocol type; and
adding the pack header to the media data corresponding to the function type, and transmitting the packed media data to the communication interface corresponding to the external device.

9. An electronic device, comprising:
a processor;
a memory device storing instructions executable by the processor; wherein
the processor is configured to execute the instructions stored in the memory to implement a multi-dimensional media data transmission method comprising:
acquiring a plurality of function types of multi-dimensional media data to be transmitted, wherein the media data of different dimensions correspond to different function types;
determining an external device for outputting media data corresponding to a function type; and
packaging the media data corresponding to the function type according to a communication protocol type of the external device, and transmitting the packaged media data through a communication interface corresponding to the external device.

10. The electronic device according to claim 9, wherein the determining the external device for outputting the media data corresponding to the function type comprises:
sending an external device query instruction carrying a function type identifier to a registration management module;
receiving an external device list feedback by the registration management module based on the function type identifier; and
determining at least one external device in the external device list as the external device for outputting the media data corresponding to the function type;
wherein the external device for outputting the media data corresponding to the function type is registered with the registration management module in advance.

11. The electronic device according to claim 10, wherein the external device list carries external device identifiers and communication protocol types corresponding to the function type; and
The determining the external device for outputting the media data corresponding to the function type comprises:
determining a preset communication protocol type from the communication protocol types corresponding to the function type; and
determining the external device for outputting the media data corresponding to the function type according to an external device identifier corresponding to the preset communication protocol type.

12. The electronic device according to claim 9, wherein the determining the external device for outputting the media data corresponding to the function type comprises:
determining an external device historically-used for transmitting the multimedia data corresponding to the function type as the external device for transmitting the multimedia data corresponding to the function type in this transmission according to a historical query result.

13. The electronic device according to claim 9, wherein the packaging the media data corresponding to the function type according to the communication protocol type of the external device comprises:
generating a pack header for the media data according to the function type, the communication protocol type, and a preset communication protocol type; and
adding the pack header to the media data corresponding to the function type, and transmitting the packed media data to the communication interface corresponding to the external device.

14. The electronic device according to claim 10, wherein the packaging the media data corresponding to the function type according to the communication protocol type of the external device comprises:
generating a pack header for the media data according to the function type, the communication protocol type, and a preset communication protocol type; and
adding the pack header to the media data corresponding to the function type, and transmitting the packed media data to the communication interface corresponding to the external device.

15. The electronic device according to claim 11, wherein the packaging the media data corresponding to the function type according to the communication protocol type of the external device comprises:
generating a pack header for the media data according to the function type, the communication protocol type, and a preset communication protocol type; and
adding the pack header to the media data corresponding to the function type, and transmitting the packed media data to the communication interface corresponding to the external device.

16. A non-transitory computer-readable storage medium, having executable instructions stored thereon that, when executed by a processor, implement a multi-dimensional media data transmission method comprising:
acquiring a plurality of function types of multi-dimensional media data to be transmitted, wherein the media data of different dimensions correspond to different function types;
determining an external device for outputting media data corresponding to a function type; and
packaging the media data corresponding to the function type according to a communication protocol type of the external device, and transmitting the packaged media data through a communication interface corresponding to the external device.

17. The non-transitory computer-readable storage medium according to claim 16, wherein the determining the external device for outputting the media data corresponding to the function type comprises:
sending an external device query instruction carrying a function type identifier to a registration management module;
receiving an external device list feedback by the registration management module based on the function type identifier;
determining at least one external device in the external device list as the external device for outputting the media data corresponding to the function type;
wherein the external device for outputting the media data corresponding to the function type is registered with the registration management module in advance.

18. The non-transitory computer-readable storage medium according to claim 17, wherein the external device list carries external device identifiers and communication protocol types corresponding to the function type; and
the determining the external device for outputting the media data corresponding to the function type comprises:
determining a preset communication protocol type from the communication protocol types corresponding to the function type; and
determining the external device for outputting the media data corresponding to the function type according to an external device identifier corresponding to the preset communication protocol type.

19. The non-transitory computer-readable storage medium according to claim 16, wherein
the determining the external device for outputting the media data corresponding to the function type comprises:
determining an external device historically-used for transmitting the multimedia data corresponding to the function type as the external device for transmitting the multimedia data corresponding to the function type in this transmission according to a historical query result; and
the packaging the media data corresponding to the function type according to the communication protocol type of the external device comprises:
generating a pack header for the media data according to the function type, the communication protocol type, and a preset communication protocol type; and
adding the pack header to the media data corresponding to the function type, and transmitting the packed media data to the communication interface corresponding to the external device.

20. A multimedia system implementing the method according to claim 1, comprising:
a registration component;
a common interface; and
a plurality of external devices;
wherein
the common interface is configured to transmit the multi-dimensional media data to extend to the plurality of external devices, thereby facilitating sharing hardware resources and developing upper layer application software, to establish an open source software and hardware ecosystem;
the plurality of external devices are configured to register with the registration management component through a driver layer;
the driver layer is configured to add a data structure to store a function type of each of the plurality of external devices;
upon an application being triggered, a system upper framework layer is configured to obtain the function types of the media data of respective dimensions in the multi-dimensional media data, and query the registration management module through a broadcast to obtain an available external device list;
the data packets are packaged respectively according to the communication protocol type including at least one of USB, IR, Bluetooth (BT), or Wi-Fi, corresponding to each external device in the external device list;
the packaged data are transmitted to a corresponding communication interface through the driver layer, and then sent to a corresponding external device by the communication interface; and
the plurality of the external devices include at least one of a vision-related device, a hearing-related device, a smell-related device, a touch-related device, and a motion-related device.
